(19) United States
(12) Patent Application Publication
(10) Pub. No.: US 2025/0162694 A1
(43) Pub. Date: May 22, 2025

(54) FLOATING PLATFORM WITH MULTI-FREQUENCY ADAPTIVE VIBRATION DAMPING AND OFFSHORE WIND POWER SYSTEM

(71) Applicant: HUAZHONG UNIVERSITY OF SCIENCE AND TECHNOLOGY, Hubei (CN)

(72) Inventors: Zhenqing Liu, Hubei (CN); Changjian Wan, Hubei (CN); Shuanglong Fan, Hubei (CN)

(73) Assignee: HUAZHONG UNIVERSITY OF SCIENCE AND TECHNOLOGY, Hubei (CN)

(21) Appl. No.: 18/664,246

(22) Filed: May 14, 2024

(30) Foreign Application Priority Data
Nov. 20, 2023 (CN) 202311546840.3

(51) Int. Cl. B63B 39/00; B63B 35/44; B63B 39/03

(52) U.S. Cl. CPC B63B 39/005; B63B 39/03; B63B 2035/446

(57) ABSTRACT

A floating platform with multi-frequency adaptive vibration damping and an offshore wind power system. The floating platform includes a platform body. An internal space of the platform body is divided by partitions to form a plurality of independent compartments. The compartments are used to hold water to form tuned liquid dampers (TLDs), so that a vibration damping effect on the platform body is achieved through the sloshing of water. The compartments form multi-order TLDs. Setting parameters of water in the compartments corresponding to the TLDs of different orders are different. The multi-order TLDs correspond to multi-order vibration frequencies of the platform body.

### CROSS-REFERENCE TO RELATED APPLICATION

This application claims the priority benefit of China application serial no. 202311546840.3, filed on Nov. 20, 2023. The entirety of the above-mentioned patent application is hereby incorporated by reference herein and made a part of this specification.

### BACKGROUND

### Technical Field

The disclosure belongs to the technical field related to vibration control, and more specifically, relates to a floating platform with multi-frequency adaptive vibration damping and an offshore wind power system.

### Description of Related Art

In the field of wind power generation, with the continuous development of wind power technology, offshore wind power will not be able to meet the needs of renewable energy development in the future. With the continuous improvement of theoretical knowledge and the gradual development of construction technology, people have begun to explore deeper and further sea areas in order to obtain wind energy resources in a larger sea area. The development of offshore wind power will inevitably shift from shallow seas to deep seas in the future. The costs of conventional fixed foundations are excessively high, and their stability cannot be guaranteed to be used in deep sea environments. Floating foundations are suitable for water depths above 60 m, so floating foundations will surely become the optimal choice for deep-sea wind power development in the future.

Floating wind turbine platforms can be divided into 4 basic types according to their differences in obtaining static stability: spar platforms, tension leg platforms (TLP), semi-submersible platforms, and barge-type platforms. Among these platforms, the barge-type floating platform has obvious advantages compared with the other three types. First of all, the barge platform can be simplified as a weightless pontoon, and the large water area moment of the barge platform can provide sufficient restoring moment to ensure that the entire platform system does not overturn under various sea conditions, and good stability is thereby provided. Second, as far as the current manufacturing level is concerned, the barge platform has the lowest cost per unit weight and has a relatively simple structure. Further, manufacturing costs can also be further lowered due to mature shipbuilding technology.

However, floating wind turbines have more technical difficulties than onshore wind turbines and offshore fixed-pile wind turbines. One of the difficulties is that in the marine environment, affected by combined environmental loads such as wind, waves, and currents, the movement will be dominated by the overall rigid displacement of the floating platform and the wind turbine, rather than the vibration inside the wind turbine structure. The second difficulty is that the action of waves and ocean currents causes the offshore floating wind turbine floating platform to produce pitching and rolling movement. As a result, the inflow wind speed of the wind turbine fluctuates greatly and the aerodynamic load increases significantly, causing a large simple harmonic vibration response of the generator and the nacelle. The overall output power, power generation, and stability of offshore wind farms thus have been affected to varying degrees. Therefore, how to control vibration damping on floating platforms is a current research hotspot in offshore wind power.

There are two main approaches for vibration control research on offshore floating wind turbine platforms: active control and passive control. Considering the complex load environment and multi-directional frequency vibration characteristics of offshore wind turbines, the use of active control technology requires a large amount of formula derivation and simulation research, which is time-consuming and labor-intensive and is less practical for actual projects. As for the existing passive control technology, for vibration damping research on barge-type offshore floating wind turbine platforms, a tuned mass damper (TMD) system is chosen most of the time to be installed in the nacelle for dynamic response analysis. However, the size of the nacelle is limited, and the TMD mass is excessively large, making it inconvenient to install and adjust, so its vibration damping effect is seriously limited. In addition, using a single mass and damping coefficient for TMDs can only control the vibration frequency in a single direction. If frequencies in multiple directions need to be controlled, the number and costs of TMDs will be greatly increased, which is obviously not suitable for the complex movements of offshore wind turbine floating platforms and is less practical for actual engineering projects. Further, the vibration control frequency domain of TMDs is relatively narrow and is relatively sensitive to the natural vibration frequency of the structure. That is, the natural frequency must be consistent with the frequency of the controlled structure to achieve the best effect, so only a single frequency can be controlled for vibration damping. The movement frequencies of floating platforms under the combined loads of wind, waves, and currents are diverse, so it is necessary to expand the vibration damping frequency range to achieve a broadband and wide-area vibration damping effect on the floating platform.

Problems such as complex structures, inconvenient installation, being unable to be applied to multi-directional and multi-frequency complex vibrations of floating platforms, and poor practicability can be found in currently-available vibration control methods for offshore floating platforms.

### SUMMARY

In view of the above defects or improvement needs of the related art, the disclosure provides a floating platform with multi-frequency adaptive vibration damping and an offshore wind power system capable of solving the problems such as complex structures, inconvenient installation, being unable to be applied to multi-directional and multi-frequency complex vibrations of floating platforms, and poor practicability found in currently-available vibration control methods for offshore floating platforms.

To achieve the above, in an aspect of the disclosure, the disclosure provides a floating platform with multi-frequency adaptive vibration damping including a platform body. An internal space of the platform body is divided by partitions to form a plurality of independent compartments. The compartments are used to hold water to form tuned liquid dampers (TLDs), so that a vibration damping effect on the platform body is achieved through the sloshing of water. The compartments form multi-order TLDs. Setting parameters of water in the compartments corresponding to the TLDs of different orders are different. The multi-order TLDs correspond to multi-order vibration frequencies of the platform body.

According to the floating platform with multi-frequency adaptive vibration damping provided by the disclosure, the compartments include a first compartment and a second compartment. The setting parameter of water in the first compartment is such that a sloshing frequency of water is adapted to a first-order vibration frequency of the platform body. The setting parameter of water in the second compartment is such that the sloshing frequency of water is adapted to a second-order vibration frequency of the platform body.

According to the floating platform with multi-frequency adaptive vibration damping provided by the disclosure, a plurality of first compartments are arranged along a circumference of the platform body, and the first compartments are symmetrically distributed about a center of the platform body. A plurality of second compartments are arranged along the circumference of the platform body, and the second compartments are symmetrically distributed about the center of the platform body.

According to the floating platform with multi-frequency adaptive vibration damping provided by the disclosure, the platform body has a centrally symmetrical annular hollow structure, and the platform body has four sides.

Four corners of the platform body are set as the first compartments or the second compartments, and correspondingly, middle portions of the sides of the platform body are set as the second compartments or the first compartments.

Alternatively, three compartments are arranged on each side of the platform body. Among the three compartments on each side of the platform body, the compartments located on both sides are set as the first compartments or the second compartments, and correspondingly, the compartment in the middle among the three compartments on each side of the platform body is set as the second compartment or the first compartment.

According to the floating platform with multi-frequency adaptive vibration damping provided by the disclosure, the first compartment and the second compartment are set as rectangular regions. A water depth ratio of water in the first compartment is 0.15 to 0.2, and a ratio of a total mass of water in the first compartment to a mass of the platform body is 1% to 4%. A water depth ratio of water in the second compartment is 0.2 to 0.3, and a ratio of a total mass of water in the second compartment to the mass of the platform body is 1% to 4%. Herein, the water depth ratio is a ratio of a depth of water to a corresponding length of the compartment in a vibration direction.

According to the floating platform with multi-frequency adaptive vibration damping provided by the disclosure, the first compartment and the second compartment are set as rectangular regions. A depth of water in the first compartment and the second compartment is calculated and obtained through the following:

$${ω}_{n} = \sqrt{\frac{n π g}{L} tanh ( \frac{n π h}{L} )} ,$$

where ωₙ is a n^{th}-order vibration frequency of the platform body, g is a gravitational acceleration, which is 9.8 m/s², h is the depth of water in the compartment, and L is a length of the compartment in a vibration direction.

According to the floating platform with multi-frequency adaptive vibration damping provided by the disclosure, a damping structure is further provided inside each of the first compartment and the second compartment, and the damping structure includes at least one of a grid, a baffle, and a column.

According to the floating platform with multi-frequency adaptive vibration damping provided by the disclosure, the first compartment and the second compartment are set as rectangular regions. An equivalent damping coefficient of the damping structure in each of the first compartment and the second compartment is calculated and obtained through the following:

$${m}_{e q} {\ddot{x}}_{r} ( t ) + {c}_{e q} {\dot{x}}_{r} ( t ) + {k}_{e q} {x}_{r} ( t ) = - {m}_{e q} \ddot{X} ( t ) ,$$

$${m}_{e q} = \frac{8 ρ b {L}^{2}}{{π}^{3}} tanh ( \frac{π h}{L} ) , and$$

$${k}_{e q} = \frac{8 ρ g b L}{{π}^{2}} {tanh}^{2} ( \frac{π h}{L} ) ,$$

where \ddot{X} represents an acceleration of external excitation at a bottom portion of the compartment, t represents time, xᵣ represents a displacement of water inside the compartment relative to the compartment, m_{eq} represents an equivalent mass of water inside the compartment; c_{eq} represents the equivalent damping coefficient of the damping structure, k_{eq} represents equivalent stiffness of the tuned liquid damper formed by the compartment; ρ is a water density, L and b respectively are the length and a width of the compartment in the vibration direction, g is the gravitational acceleration, and h is the depth of water in the compartment.

According to the floating platform with multi-frequency adaptive vibration damping provided by the disclosure, the damping structure is a perforated baffle, and setting parameters of the perforated baffle are calculated and obtained through the following:

$${c}_{e q} = 2 {m}_{e q} {ω}_{n} {ξ}_{V e q} ,$$

$${ξ}_{V e q} = {ξ}_{0} {x}_{0} ,$$

$${ξ}_{0} = \frac{16}{3 π} {tanh}^{2} ( \frac{π h}{L} ) {C}_{D} {Δ}_{V} {Θ}_{V n} \frac{1}{{L}^{2}} ,$$

$${x}_{0} = \sqrt{\frac{{X}_{0}}{2 {ξ}_{0}}} ,$$

$${C}_{D} = {( \frac{1}{{C}_{c} ( 1 - S )} - 1 )}^{2} ,$$

$$S = \frac{{A}_{s}}{{A}_{T}} ,$$

$${C}_{c} = 0.405 {e}^{- π S} + 0.5 \; 95 ,$$

$${Δ}_{V} = {\int }_{- h}^{- h + {l}_{b}} \frac{{cosh}^{3} ( \frac{π ( z + h )}{L} )}{{sinh}^{3} ( \frac{π h}{L} )} dz , and$$

$${Θ}_{V n} = {\sum }_{i = 1}^{n} \vert sin ( \frac{π {x}_{i}}{L} ) \vert {sin}^{2} ( \frac{π {x}_{i}}{L} ) ,$$

where ωₙ is the n^{th}-order vibration frequency of the platform body, ξ_{Veq} is a linear damping ratio of the tuned liquid damper formed by the compartment, x₀ is a relative horizontal displacement amplitude value of an equivalent linear model of the compartment, X₀ is a displacement amplitude value of the external excitation at the bottom portion of the compartment, C_{D} is a pressure loss coefficient caused by the built-in perforated baffle, Δ_{V} and Θ_{Vn} are calculation parameters in a theoretical derivation process of linear damping ratio calculation, S is a shielding ratio of the perforated baffle, C_{c} is a shrinkage coefficient, Aₛ is an area of a solid portion of the perforated baffle that is immersed in water, A_{T} is a total area of the perforated baffle immersed in water, l_{b} is a height of the perforated baffle, z is a height direction, and xᵢ is a distance between an i^{th} perforated baffle and a side wall of the compartment.

According to another aspect of the disclosure, the disclosure further provides an offshore wind power system including the floating platform with multi-frequency adaptive vibration damping according to any one of the above and a wind turbine fixed to the floating platform.

In general, when the above technical solution provided by the disclosure is compared to the related art, the floating platform with multi-frequency adaptive vibration damping and the offshore wind power system provided by the disclosure exhibit the following features.
1. The internal space of the platform body is divided into a plurality of compartments. The compartments are used to hold water. The sloshing of water in the floating platform is used to generate water pressure on the inner wall of the platform, which reacts on the platform, so that the nonlinear movement of the platform with multiple degrees of freedom is limited. This arrangement is economical and simple. Basically, the purpose of vibration damping can be achieved with only a small increase in civil construction costs, so the construction costs and maintenance costs are considerably reduced. Further, the floating platform's advantages such as large space and good practicability are fully utilized, so it is highly practical and has good practical significance for actual projects.
2. By utilizing the sloshing excitation of the water flow in random directions, the adaptive vibration damping effect of the floating-type platform in multiple directions can be achieved. Its separated sealed compartments can be used to achieve vibration damping at multiple vibration frequencies, and the vibration damping frequency range is thus wider. Further, for external forces in multiple directions, corresponding reaction forces can be provided, so multi-directional joint vibration control is achieved. The problems of single direction and single frequency of most of the existing TMDs are effectively solved, and it is practical for the complex movement of offshore floating-type platforms.
3. In order to reduce the sloshing behavior of water in the floating-type platform and improve its ability to absorb and dissipate energy, a method of providing a built-in damping structure is adopted. The inherent damping of water sloshing in the platform is increased, and the nonlinear sloshing of additional water in the platform is suppressed, so the robustness and effectiveness of the vibration damping system is improved.
4. The physical parameters of each additional perforated damping baffle, such as the baffle height, shielding ratio, baffle position, etc., are calculated, obtained, and optimally set according to the external load environment of the floating-type platform and its structural natural vibration frequency to maximize its vibration damping effect.

### BRIEF DESCRIPTION OF THE DRAWINGS

FIG. 1 is front view of an offshore wind power system provided by the disclosure.

FIG. 2 is top view of the offshore wind power system provided by the disclosure.

FIG. 3 is side view of the offshore wind power system provided by the disclosure.

FIG. 4 is a first schematic view of an internal structure of a floating platform with multi-frequency adaptive vibration damping provided by the disclosure.

FIG. 5 is a second schematic view of the internal structure of the floating platform with multi-frequency adaptive vibration damping provided by the disclosure.

FIG. 6 is a schematic view of a perforated baffle provided by the disclosure.

FIG. 7 is a schematic diagram of an equivalent mechanical model of a tuned liquid damper (TLD) formed by compartments provided by the disclosure.

FIG. 8 is a schematic diagram of a theoretical calculation model of a compartment with a perforated baffle mounted on a bottom portion provided by the disclosure.

In the accompanying drawings, the same reference numerals are used to represent identical or similar elements or structures, where:
1: wind turbine tower, 2: wind turbine blade, 3: platform body, 4: mooring system anchor chain, 5: first compartment, 6: second compartment, 7: partition, 8: floating body-mooring and anchoring device, and 9: perforated baffle.

### DESCRIPTION OF THE EMBODIMENTS

In order to make the objectives, technical solutions, and advantages of the disclosure clearer and more comprehensible, the disclosure is further described in detail with reference to the drawings and embodiments. It should be understood that the specific embodiments described herein serve to explain the invention merely and are not used to limit the invention. In addition, the technical features involved in the various embodiments of the invention described below can be combined with each other as long as the technical features do not conflict with each other.

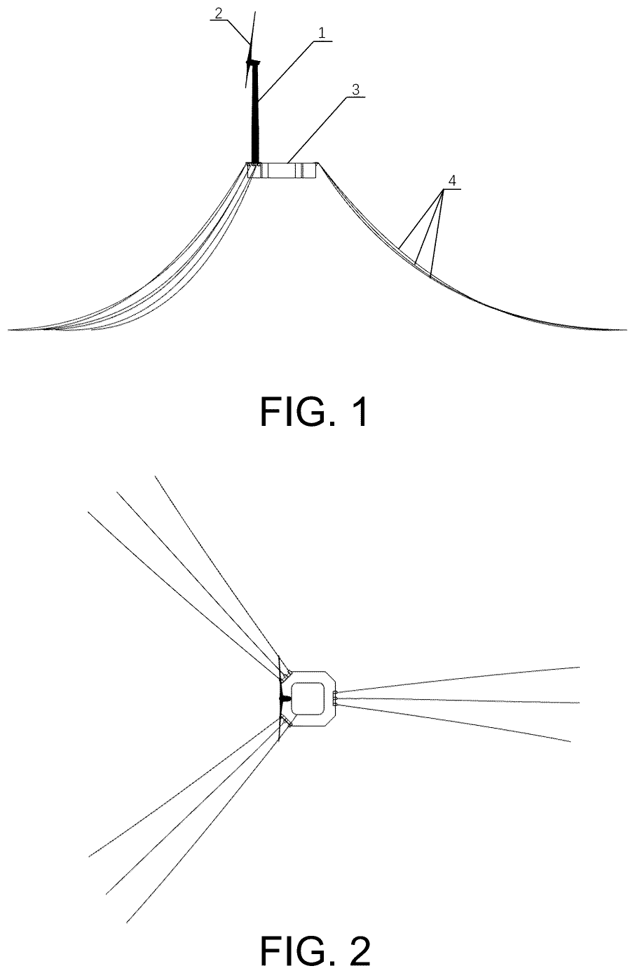

With reference to FIG. 1 to FIG. 4, in the disclosure, a floating platform with multi-frequency adaptive vibration damping is provided, and the floating platform includes a platform body 3. An internal space of the platform body 3 is divided by partitions 7 to form a plurality of independent compartments. The compartments are used to hold water to form tuned liquid dampers (TLDs), so that a vibration damping effect on the platform body 3 can be achieved through the sloshing of water. The compartments form multi-order TLDs. Setting parameters of water in the compartments corresponding to the TLDs of different orders are different. The multi-order TLDs correspond to multi-order vibration frequencies of the platform body 3.

In the disclosure, the TLDs are organically combined with a barge-type floating platform. A TLD water tank is formed inside the floating platform body 3 by adding water into the floating platform body 3. The sloshing of the liquid in the water tank is used to generate a dynamic side pressure to provide a vibration damping force. Further, the inside of the platform body 3 is divided into a plurality of sealed compartments that are not connected to each other by using the rigid partitions 7. The compartments are used to hold water to form the TLDs, and each water-filled compartment may be treated as a TLD water tank. Water with different mass ratios and water depth ratios may be filled in different compartments, so that a variety of TLDs with different sloshing frequencies are formed, which are used to control different vibration frequencies of the floating platform.

When the floating platform body 3 is subjected to the combined load of wind, waves, and currents in the marine environment and reaches the resonance frequency, dynamic responses such as displacement, speed, and acceleration generated by the floating platform body 3 drive the vibration and sloshing of the water in the compartments inside the platform and activate a large number of wave breaking on the water surface. The water pressure generated by the large number of wave breaking on the inner wall of the platform in turn affects the movement of the platform. The friction of a boundary layer and wave breaking during the adaptive sloshing of the water flow are used to absorb and dissipate the vibration energy of the floating platform, so that effective vibration damping of the floating platform is achieved, and the complex and changeable load effects generated by the marine environment are fully dealt with.

In the floating platform with multi-frequency adaptive vibration damping provided by the disclosure, the internal space of the platform body 3 is divided into multiple compartments, and the compartments are used to hold water. The sloshing of water in the floating platform is used to generate water pressure on the inner wall of the platform, which reacts on the platform, so that the nonlinear movement of the platform with multiple degrees of freedom is limited. This arrangement is economical and simple. Basically, the purpose of vibration damping can be achieved with only a small increase in civil construction costs, so the construction costs and maintenance costs are considerably reduced. Further, the floating platform's advantages such as large space and good practicability are fully utilized, so it is highly practical and has good practical significance for actual projects.

By utilizing the sloshing excitation of the water flow in random directions, the adaptive vibration damping effect of the floating-type platform in multiple directions can be achieved. Its separated sealed compartments can be used to achieve vibration damping at multiple vibration frequencies, and the vibration damping frequency range is thus wider. Further, for external forces in multiple directions, corresponding reaction forces may be provided, so multi-directional joint vibration control is achieved. The problems of single direction and single frequency of most of the existing TMDs are effectively solved, and it is practical for the complex movement of offshore floating-type platforms.

In some embodiments, the plurality of compartments include a first compartment 5 and a second compartment 6. The setting parameter of water in the first compartment 5 is such that a sloshing frequency of water is adapted to a first-order vibration frequency of the platform body 3. The setting parameter of water in the second compartment 6 is such that the sloshing frequency of water is adapted to a second-order vibration frequency of the platform body 3. That is, the plurality of compartments include the first compartment 5 corresponding to the first-order vibration frequency of the control platform body 3 as well as the second compartment 6 corresponding to the second-order vibration frequency of the control platform body 3. Specifically, different vibration frequencies may be achieved by changing the setting parameters of water in the compartments.

In the disclosure, considering that the high-order vibration frequency of the floating platform is difficult to excite and the high-order frequency term participates in a small proportion of the vibration energy, therefore, the main setting in the disclosure is to control the first- and second-order natural frequencies of the floating platform. Correspondingly, the first compartment 5 and the second compartment 6 are provided in the plurality of compartments, the first compartment 5 forms a first-order TLD, and the second compartment 6 forms a second-order TLD. The sloshing frequencies of the two types of TLDs are set near the first- and second-order vibration frequencies of the floating platform. In this way, when the floating platform resonates under external load excitation, a good vibration damping effect on the first- and second-order vibration of the floating platform is achieved, which is also more practical.

To be specific, a plurality of first compartments 5 are arranged along a circumference of the platform body 3, and the first compartments 5 are symmetrically distributed about a center of the platform body 3. A plurality of second compartments 6 are arranged along the circumference of the platform body 3, and the second compartments 6 are symmetrically distributed about the center of the platform body 3. That is, the first compartments 5 are symmetrically distributed about the center of the platform body 3, and the second compartments 6 are also symmetrically distributed about the center of the platform body 3. Such an arrangement is conducive to achieving a uniform vibration damping effect on the platform body 3 and improving the stability of the platform body 3.

In some embodiments, the platform body 3 has a centrally symmetrical annular hollow structure, and the platform body 3 has four sides.

Four corners of the platform body 3 are set as the first compartments 5 or the second compartments 6, and correspondingly, middle portions of the sides of the platform body 3 are set as the second compartments 6 or the first compartments 5.

With reference to FIG. 4, in this embodiment, the platform body 3 has a centrally symmetrical structure, and the platform body 3 may be an octahedral shell structure made of steel. That is, an outer side wall of the platform body 3 is in the shape of an octahedron, and a rounded square runs through the center. The entire floating platform body 3 is divided into eight sealed compartments by the partitions 7. By adjusting a water depth and a mass ratio of the additional water inside each compartment, the compartments can control different vibration frequencies of the floating platform. In this embodiment, the eight sealed compartments include four first compartments 5 of a same size and four second compartments 6 of a same size. The first compartments 5 may be distributed in middle positions of the front, rear, left, and right of the platform body 3 and are arranged symmetrically with the center of the platform body 3, so that the platform is ensured to receive even force. Correspondingly, the second compartments 6 are distributed at the four corners of the platform body 3 and are arranged symmetrically with the center of the platform body 3, so that the platform is also ensured to receive even force. The first compartments 5 may be set as low-frequency vibration control compartments, corresponding to and controlling the first-order vibration frequency of the platform body 3. The second compartments 6 are set as relatively high-frequency vibration control compartments, corresponding to and controlling the second-order vibration frequency of the platform body 3.

The first compartments 5 may also be distributed at the four corners of the platform body 3 and are arranged symmetrically with the center of the platform body 3, so that the platform is ensured to receive even force. Correspondingly, the second compartments 6 are distributed in the middle positions of the front, rear, left, and right of the platform body 3 and are arranged symmetrically with the center of the platform body 3, so that the platform is ensured to receive even force. Specific arrangement is not particularly limited. This arrangement may make full use of the space inside the platform body 3, provide the largest arrangement space for the TLDs, and is conducive to obtaining the optimal vibration damping effect.

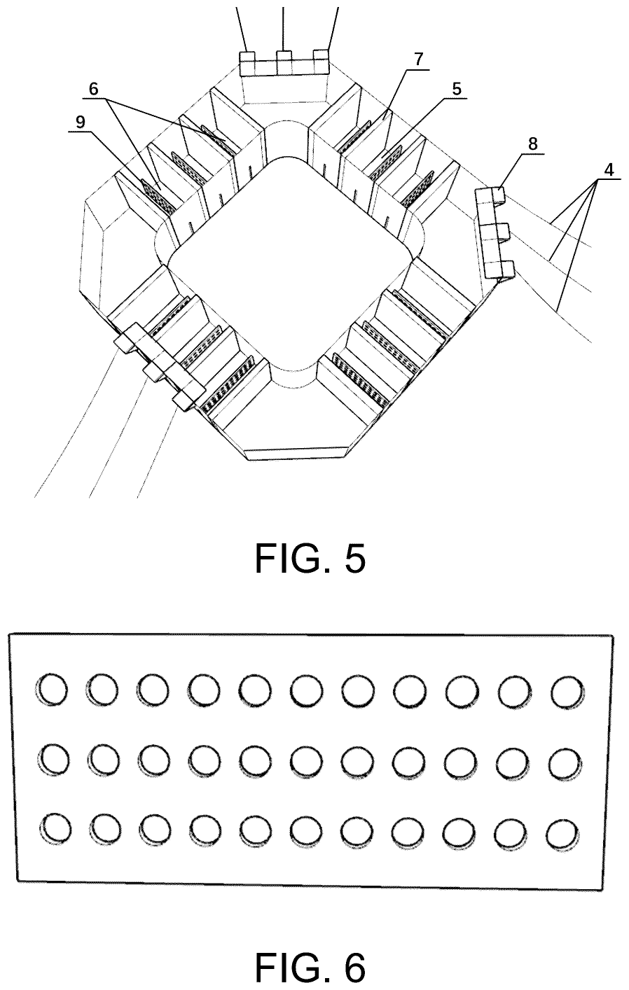

In another embodiment, the specific location distribution of the first compartments 5 and the second compartments 6 may also be other arrangement. For instance, with reference to FIG. 5, three compartments are arranged on each side of the platform body 3. Among the three compartments on each side of the platform body 3, the compartments located on both sides are set as the first compartments 5 or the second compartments 6. Correspondingly, the compartment in the middle among the three compartments on each side of the platform body 3 is set as the second compartment 6 or the first compartment 5. The three compartments on each side of the platform body 3 may be arranged symmetrically about the middle portion of the side. It can also be ensured that the first compartments 5 and the second compartments 6 are distributed symmetrically about the center of the platform body 3. This arrangement is also conducive to making the shapes of the first compartments 5 and the second compartments 6 both regular rectangles, making it easier to calculate and obtain relevant setting parameters in the compartments. The specific position distribution of the first compartments 5 and the second compartments 6 is not limited, and the purpose is to be symmetrical about the center of the platform body 3, so that a favorable vibration damping effect may be achieved.

In some embodiments, the first compartments 5 and the second compartments 6 are set as rectangular regions. A water depth ratio of water in each first compartment 5 is 0.15 to 0.2, and a ratio of a total mass of water in the first compartments 5 to a mass of the platform body is 1% to 4%. That is, when multiple first compartments 5 are provided, the water depth ratio of water in each first compartment 5 may be selected according to the above water depth ratio range, and the ratio of the total mass of water in the multiple first compartments 5 to the mass of the platform body 3 may be selected according to the above mass ratio range. A water depth ratio of water in each second compartment 6 is 0.2 to 0.3, and a ratio of a total mass of water in the second compartments 6 to the mass of the platform body 3 is 1% to 4%. Herein, the water depth ratio is a ratio of a depth of water to a corresponding length of the compartment in a vibration direction.

When the setting parameters of water in each first compartment 5 are selected within the above range, the formed first-order TLD may better adapt to the first-order vibration frequency of the offshore platform body 3, so that the first-order vibration of the platform body 3 is better controlled. When the setting parameters of water in each second compartment 6 are selected within the above range, the formed second-order TLD may better adapt to the second-order vibration frequency of the offshore platform body 3, so that the second-order vibration of the platform body 3 is better controlled. The length of the compartment in the vibration direction is usually the length of the longer side of the compartment.

To be specific, the first compartments 5 and the second compartments 6 are set as rectangular regions. A depth of water in each first compartment 5 and each second compartment 6 is calculated and obtained through the following:

The natural frequencies of each order corresponding to the TLD system are calculated according to the linear potential flow theory as follows, and the setting parameter of water depth in the compartment may be calculated according to this calculation formula:

$${ω}_{n} = \sqrt{\frac{n π g}{L} tanh ( \frac{n π h}{L} )} , \qquad ( 1 )$$

where ωₙ is a n^{th}-order vibration frequency of the platform body 3. When the compartment corresponds to the n^{th}-order vibration frequency of the control platform body 3, the vibration frequency may be set as the sloshing frequency of the compartment. For instance, n=1 corresponds to the first-order sloshing frequency of the TLD. The first-order vibration frequency of the platform body 3 may be taken as the first-order sloshing frequency of the TLD, which corresponds to obtaining the depth parameter of water in the first compartment 5. n=2 corresponds to obtaining the depth parameter of water in the second compartment 6. g is a gravitational acceleration, which is 9.8 m/s², h is the depth of water in the compartment, L is the length of the compartment in the vibration direction, and the water depth ratio is h/L.

Through the above calculation formula, the setting parameters of water in the corresponding compartment are obtained according to the vibration frequency of the platform body 3, and the sloshing frequency of water in each compartment may be adjusted to different natural frequencies of the platform body 3. The platform body 3 may be activated under different vibration frequencies of the platform body 3 to correspond to a large amount of sloshing and wave breaking of water in the corresponding compartment. In this way, the floating-type platform may dissipate a certain amount of vibration energy at the resonance frequency, and multi-frequency adaptive vibration damping of the platform body 3 is thus achieved.

The n^{th}-order vibration frequency of the platform body 3 may be obtained through numerical simulation experiments on the platform body 3, and description of the obtaining process is not provided herein. Further, the above calculation method of the depth of water in each compartment is more suitable for the case where the compartment is rectangular. When the compartment is rectangular, L is the length of the long side of the rectangular compartment.

When the compartment is an irregular non-rectangular region, such as an irregular polygon, L may be the length of the longer side, and when the compartment is circular, L may be the diameter. The optimal value of the water depth setting may also be obtained through the above formula. When the compartment is an irregular non-rectangular region, if the irregular non-rectangular region may be divided into multiple rectangular regions, the water depth setting parameters may also be obtained by calculating the above formula for any rectangular region. The water depth of other rectangular regions is consistent with the water depth of this rectangular region. When the compartment is an irregular non-rectangular region, experiments or numerical simulation methods may also be used to adjust its water depth ratio. In the case where the sloshing frequency is close to the natural frequency of the platform body 3, the minimum sloshing amplitude of water is the goal to obtain optimal water depth ratio setting parameters. The natural frequency of the platform may also be obtained through experiments or numerical simulations.

Further, a damping structure is further provided inside each of the first compartments 5 and the second compartments 6, and the damping structure includes at least one of a grid, a baffle, and a column.

In this embodiment, considering that the viscosity of water is relatively small, a damping ratio provided by frictional energy dissipation of the boundary layer of the water tank and damping generated by the additional water in each compartment in the platform body 3 depending solely on its own sloshing cannot meet a damping ratio value required for the TLD to achieve optimal tuning. Further, excessive sloshing or occurrence of resonance may cause the liquid in the floating-type platform to violently impact the side walls of the platform, causing damage to the platform structure and making the vibration damping system ineffective. Therefore, obstacles such as grids, baffles, and columns may be placed inside the compartments to improve energy dissipation, so that the damping ratio of the water tank may be increased. In the disclosure, in order to reduce the sloshing behavior of water in the floating-type platform and improve its ability to absorb and dissipate energy, a method of providing a built-in damping structure is adopted. The inherent damping of water sloshing in the platform is increased, and the nonlinear sloshing of additional water in the platform is suppressed, so the robustness and effectiveness of the vibration damping system is improved.

To be specific, the first compartments 5 and the second compartments 6 are set as rectangular regions. An equivalent damping coefficient of the damping structure in each of the first compartments 5 and the second compartments 6 is calculated and obtained through the following:

$${m}_{e q} {\ddot{x}}_{r} ( t ) + {c}_{e q} {\dot{x}}_{r} ( t ) + {k}_{e q} {x}_{r} ( t ) = - {m}_{e q} \ddot{X} ( t ) , \qquad ( 2 )$$

$${m}_{e q} = \frac{8 ρ b {L}^{2}}{{π}^{3}} tanh ( \frac{π h}{L} ) , and \qquad ( 3 )$$

$${k}_{e q} = \frac{8 ρ g b L}{{π}^{2}} {tanh}^{2} ( \frac{π h}{L} ) , \qquad ( 4 )$$

wherein \ddot{X} represents an acceleration of external excitation at a bottom portion of the compartment, t represents time, xᵣ represents a displacement of water inside the compartment relative to the compartment, and a height change of water inside the compartment may be used as the displacement, \dot{x}ᵣ represents a displacement change speed of water inside the compartment relative to the compartment, \ddot{x}ᵣ represents a displacement acceleration of water inside the compartment relative to the compartment, m_{eq} represents an equivalent mass of water inside the compartment; c_{eq} represents the equivalent damping coefficient of the damping structure, k_{eq} represents equivalent stiffness of the TLD formed by the compartment; ρ is a water density, L and b respectively are the length and a width of the compartment in the vibration direction, g is the gravitational acceleration, and h is the depth of water in the compartment.

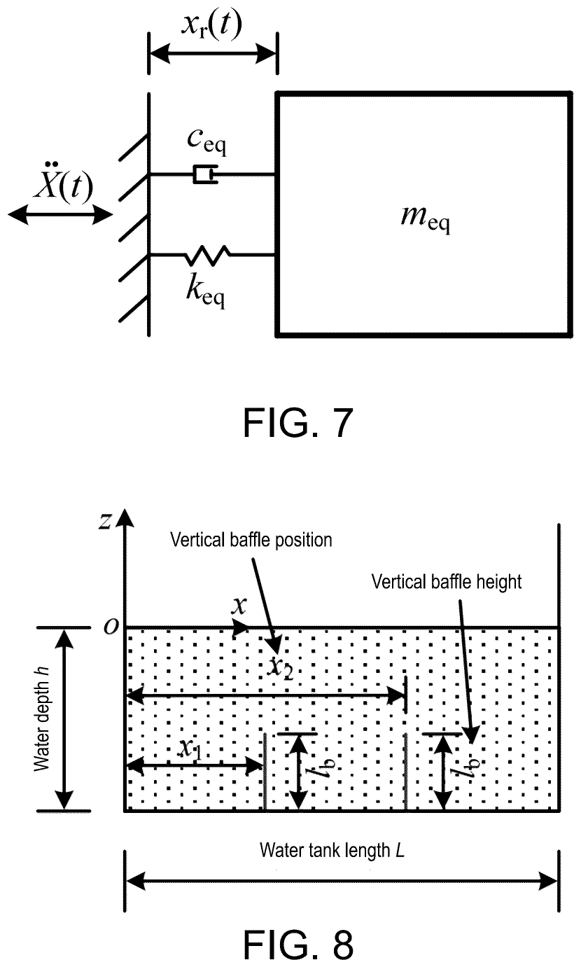

That is, numerical simulation methods may be used to obtain the equivalent damping coefficient of the damping structure in the compartment, which in turn guides the setting of the damping structure. First, after the setting parameters of water inside the compartment are determined in the above embodiments, a TLD equivalent dynamic model of the compartment containing water is obtained. As shown in FIG. 7, the water in the compartment is treated as an equivalent mass block, an equivalent linearized spring-mass-damping system is established, and the influence of the built-in damping structure on the natural frequency of the floating platform is ignored. The movement equation of this system is as shown in formula (2) above. A simulation experiment of external excitation is performed on each of the first compartments 5 and the second compartments 6. \ddot{X} is set according to the vibration frequency of the platform body 3 correspondingly controlled by the compartment, so that it is close to the vibration frequency of the platform body 3 controlled correspondingly by the compartment. For instance, when \ddot{X} is set according to the first-order vibration frequency of the platform body 3, the equivalent damping coefficient of the damping structure in the first compartment 5 is correspondingly obtained. When \ddot{X} is set according to the second-order vibration frequency of the platform body 3, the equivalent damping coefficient of the damping structure in the second compartment 6 is correspondingly obtained. xᵣ, \dot{x}ᵣ, and \ddot{x}ᵣ are the measured values in the simulation experiment. Through this simulation experiment, the theoretical equivalent damping coefficient may then be obtained. In the damping structure, corresponding design may be carried out according to the equivalent damping coefficient of this theory, which is conducive to obtaining the optimal vibration damping effect.

To be specific, the value of L is consistent with the value rule of L in the water depth ratio in the above embodiments. When the compartment is a rectangular compartment, b is the length of the short side of the rectangular compartment, that is, the width of the compartment in the vibration direction. When the compartment is an irregular non-rectangular polygonal structure, b may be the length of its shorter side, and when the compartment is circular, b may be the diameter. When the compartment is an irregular non-rectangular region, the setting parameters of the damping structure may also be optimized and obtained through experiments or numerical simulation methods.

In some specific embodiments, with reference to FIG. 6, the damping structure adopts a built-in perforated baffle 9 to adjust the inherent damping of water in each compartment of the platform body 3. By effectively selecting the parameters of the built-in perforated baffle 9, an additional damping ratio of the platform body 3 during vibration may be effectively increased, and the sloshing amplitude of water in the platform body 3 and the dynamic response caused by external complex loads may be reduced. Further, the relevant parameters of the built-in perforated baffle 9 may also be adjusted and replaced more conveniently. In this way, the natural frequency and additional damping ratio of the floating-type platform may be easily tuned within a certain range. The multi-degree-of-freedom nonlinear movement produced by the complex external load environment on the floating-type platform is adapted, and effective vibration damping control of the barge-type floating platform is achieved.

To be specific, with reference to FIG. 8, the setting parameters of the perforated baffle 9 are calculated and obtained through the following:

$${c}_{e q} = 2 {m}_{e q} {ω}_{n} {ξ}_{V e q} , \qquad ( 5 )$$

where ωₙ is the n^{th}-order vibration frequency of the platform body 3, specifically the vibration frequency of the platform body 3 corresponding to the compartment, and ξ_{Veq} is a linear damping ratio of the TLD formed by the compartment. The linear damping ratio of the TLD system is related to the physical parameters of the built-in perforated baffle 9. The general formulas for calculating the TLD linear damping ratio of the built-in hole baffle 9 is as shown in the following formulas (6) and (7):

$${ξ}_{V e q} = {ξ}_{0} {x}_{0} , and \qquad ( 6 )$$

$${ξ}_{0} = \frac{16}{3 π} {tanh}^{2} ( \frac{π h}{L} ) {C}_{D} {Δ}_{V} {Θ}_{V n} \frac{1}{{L}^{2}} , \qquad ( 7 )$$

where in formula (7), CD is a pressure loss coefficient caused by the built-in perforated baffle 9, and Δ_{V} and Θ_{Vn} are calculation parameters in a theoretical derivation process of linear damping ratio calculation. The specific calculation formulas of the three parameters are as shown in formulas (9), (12), and (13):

$${x}_{0} = \sqrt{\frac{{X}_{0}}{2 {ξ}_{0}}} , \qquad ( 8 )$$

$${C}_{D} = {( \frac{1}{{C}_{c} ( 1 - S )} - 1 )}^{2} , \qquad ( 9 )$$

$$S = \frac{{A}_{s}}{{A}_{T}} , \qquad ( 10 )$$

$${C}_{c} = 0.405 {e}^{- π S} + 0 \text{.595} , \qquad ( 11 )$$

$${Δ}_{V} = {\int }_{- h}^{- h + {l}_{b}} \frac{{cosh}^{3} ( \frac{π ( z + h )}{L} )}{{sinh}^{3} ( \frac{π h}{L} )} dz , and \qquad ( 12 )$$

$${Θ}_{V n} = {\sum }_{i = 1}^{n} \vert sin ( \frac{π {x}_{i}}{L} ) \vert {sin}^{2} ( \frac{π {x}_{i}}{L} ) , \qquad ( 13 )$$

where x₀ is a relative horizontal displacement amplitude value of an equivalent linear model of the compartment and its expression is as shown in the above formula (8), X₀ is a displacement amplitude value of the external excitation at the bottom portion of the compartment, S is a shielding ratio of the perforated baffle 9, C_{c} is a shrinkage coefficient, Aₛ is an area of a solid portion of the perforated baffle 9 that is immersed in water, A_{T} is a total area of the perforated baffle 9 immersed in water, l_{b} is a height of the perforated baffle 9, z is a height direction, and xᵢ is a distance between an i^{th} perforated baffle 9 and a side wall of the compartment.

FIG. 8 is a schematic side view of a compartment, and FIG. 8 shows a side view of the compartment provided with two perforated baffles 9. A distance between one of the perforated baffles 9 and the side wall of the compartment is x₁, a distance between the other perforated baffle 9 and the side wall of the compartment is x₂, and L is the length of the long side of the rectangular compartment, which is the length of the water tank. The abovementioned calculation process of the setting parameters of the perforated baffle 9 involves multiple parameters such as the height of the perforated baffle 9, the shielding ratio, and the distance between the perforated baffle 9 and the side wall of the compartment, and optimal values of the parameters may be obtained through multi-parameter optimization algorithms. In order to simplify the calculation, one perforated baffle 9 may be set in the compartment, and the perforated baffle 9 is located in the middle of the compartment to divide the compartment into two symmetrical portions. The height of the perforated baffle 9 may also be preset, and a more favorable shielding ratio of the perforated baffle 9 may then be calculated and obtained.

In view of the foregoing, in the actual implementation process, according to the relevant parameters of the specific floating platform, the natural frequencies of the first two orders of the structure are obtained through numerical simulation, such as simulation or testing through ansys-fluent software. Through formula (1) or numerical simulation calculation, the water depth ratio of the TLD in each region of the floating platform may be adjusted to make it close to the natural frequency of the floating platform, so that the maximum vibration damping effect is achieved. Further, the optimal equivalent damping coefficient for the maximum vibration damping effect may be obtained through numerical simulation methods and the equivalent mechanical model of formulas (2) to (4). Based on the equivalent damping coefficient value and formulas (5) to (13), through repeated parameter adjustment, numerical simulation, and multi-parameter optimization algorithms such as genetic algorithm iterative optimization calculation, the optimal solution values for the relevant parameters of the built-in perforated baffle 9, such as the height of the perforated baffle 9, the shielding ratio, the distance between the perforated baffle 9 and the side wall of the compartment, etc., may be obtained.

The disclosure further provides an offshore wind power system including the floating platform with multi-frequency adaptive vibration damping according to any one of the above and a wind turbine fixed to the floating platform.

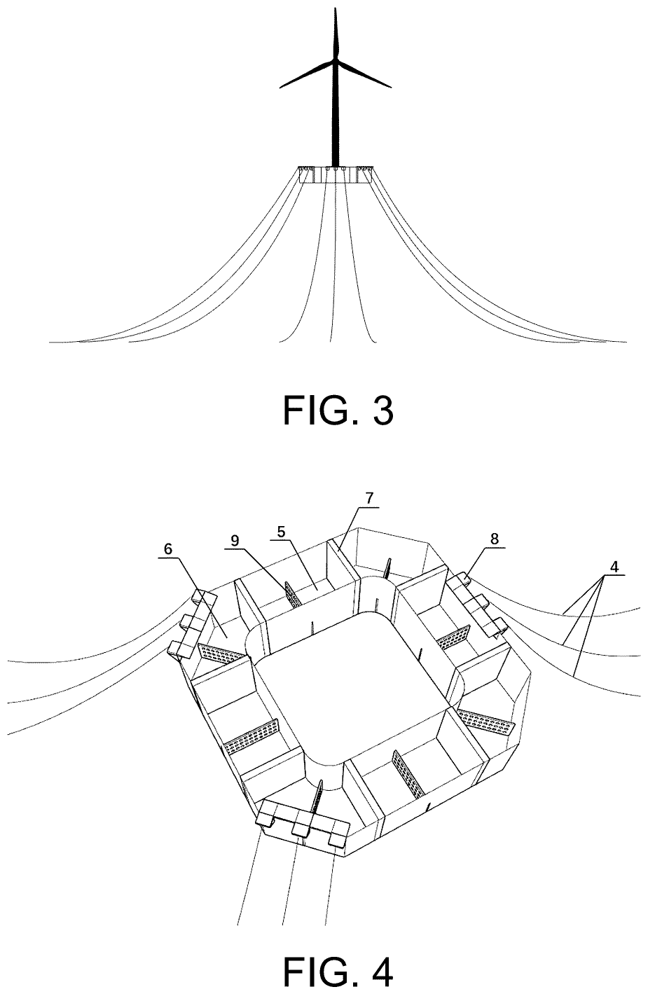

The disclosure further provides an offshore wind power system based on a floating platform with multi-frequency adaptive vibration damping. The offshore wind power system is a barge-type floating wind turbine. With reference to FIG. 1, which is a front view of the barge-type floating wind turbine. FIG. 2 is a top view of the barge-type floating wind turbine. FIG. 3 is a side view of the barge-type floating wind turbine. The wind turbine is a wind power turbine, and the wind turbine includes a wind turbine tower 1 and a wind turbine blade 2. The wind turbine tower 1 is fixed at a center edge of one side of the barge-type floating platform, and a positive direction of a wind wheel axis is an incoming flow direction. With reference to FIG. 4, three groups of nine floating body-mooring and anchoring devices 8 are evenly distributed in a triangular distribution position on an upper surface of the platform body 3. Through nine mooring system anchor chains 4, which are anchored and fixed to the seabed, excessive displacement of the floating platform is limited, and the overall structure of the barge-type floating wind turbine is formed. When the combined load of wind, waves, and currents acts, the aerodynamic load finally acts on the floating-type platform through the rotation of the wind turbine blade 2, and the aerodynamic load, together with hydrodynamic load, cause complex dynamic responses and vibration of floating-type platform.

Further, based on the needs for a simple, convenient, and effective passive control vibration damping method at present, the vibration damping and dynamic response analysis of the barge-type offshore floating-type wind turbine floating-type platform is conducted. The disclosure provides a barge-type floating platform with a built-in damping device and multi-frequency adaptive vibration damping. The barge-type floating platform is divided into sealed compartments of different sizes, and additional water with different water depth ratios and mass ratios is added into the compartments. Further, considering the lack of inherent damping, appropriate perforated rectangular damping baffles are arranged at the bottom portions of the compartments to increase the inherent damping when water sloshes in the platform. At the same time, the sloshing amplitude of water is reduced and its vibration damping ability is improved. The physical parameters of each additional perforated damping baffle, such as the baffle height, shielding ratio, baffle position, etc., may be optimally selected and set according to the external load environment of the floating-type platform and its structural natural vibration frequency to maximize its vibration damping effect.

The barge-type floating platform with the built-in damping device and multi-frequency adaptive vibration damping provided by the disclosure has built-in perforated damping baffles. In this way, the inherent damping of water sloshing in the platform may be increased, the amplitude of water sloshing in each compartment in the platform may be reduced, the stability and vibration damping ability of the vibration damping system may be improved, the system life may be longer, and the applicability may be enhanced. In practical applications of the built-in perforated damping baffles, the relevant parameters of the built-in perforated damping baffles may be adjusted by analyzing the external load conditions of the floating-type platform. The inherent damping of water sloshing in each compartment within the platform may thus be easily adjusted. Further, when the actual parameters of the floating-type platform are inconsistent with the theoretical parameters, the sloshing frequency and additional damping ratio of the TLD water tank may be easily adjusted within a certain range by changing the water depth ratio and the parameters of the built-in perforated damping baffles. The vibration damping effect is maximized, and the flexibility and practicality are enhanced.

In the actual application process, by calculating the water depth ratio of the adjustable low- and high-frequency vibration region compartments, the value is close to the natural vibration frequency of the floating platform. Under the resonant frequency load, the region compartments work together to achieve vibration damping control of different vibration frequencies of the floating platform. Further, a certain number of perforated damping baffles are evenly arranged on the bottom surfaces inside the vibration-damping compartments in order to effectively increase the inherent damping when additional water sloshes in the platform and reduce the impact of excessive sloshing amplitude on the inner wall of the platform. As shown in FIG. 6, a certain number of pores are evenly distributed on the perforated baffle 9. In actual engineering applications, by analyzing the natural frequency and period of the external environmental load, the physical parameters, such as the baffle height, shielding ratio, baffle position, etc., of the built-in damping baffles in the compartments may be changed. Through numerical simulation or experimental measurement methods, the optimal solution values of relevant parameters may be obtained to improve the platform's ability to absorb and dissipate energy and reduce the vibration response of the floating-type platform. When the external combined load acts on the floating-type platform, the sloshing of additional water in each compartment of the floating-type platform is used to generate water pressure on the inner wall of the platform, which reacts on the platform, and the movement of the platform is thus limited. Through the use of the sloshing excitation of water flow, adaptive vibration damping of the barge-type floating platform may be achieved. By adjusting various parameters of the built-in damping baffles and adjusting the damping ratio of the TLD system, the stability and vibration damping ability of the vibration damping system are improved, and the vibration damping effect effect is maximized.

A person having ordinary skill in the art should be able to easily understand that the above description is only preferred embodiments of the disclosure and is not intended to limit the disclosure. Any modifications, equivalent replacements, and modifications made without departing from the spirit and principles of the disclosure should fall within the protection scope of the disclosure.

What is claimed is:

1. A floating platform with multi-frequency adaptive vibration damping, comprising:
a platform body, wherein an internal space of the platform body is divided by partitions to form a plurality of independent compartments, the compartments are used to hold water to form tuned liquid dampers (TLDs), so that a vibration damping effect on the platform body is achieved through a sloshing of water, the compartments form multi-order tuned liquid dampers, setting parameters of water in the compartments corresponding to the tuned liquid dampers of different orders are different, and the multi-order tuned liquid dampers correspond to multi-order vibration frequencies of the platform body.

2. The floating platform with multi-frequency adaptive vibration damping according to claim 1, wherein the compartments comprise at least one first compartment and at least one second compartment, the setting parameter of water in the first compartment is such that a sloshing frequency of water is adapted to a first-order vibration frequency of the platform body, and the setting parameter of water in the second compartment is such that the sloshing frequency of water is adapted to a second-order vibration frequency of the platform body.

3. The floating platform with multi-frequency adaptive vibration damping according to claim 2, wherein a plurality of first compartments are arranged along a circumference of the platform body, the first compartments are symmetrically distributed about a center of the platform body, a plurality of second compartments are arranged along the circumference of the platform body, and the second compartments are symmetrically distributed about the center of the platform body.

4. The floating platform with multi-frequency adaptive vibration damping according to claim 3, wherein the platform body has a centrally symmetrical annular hollow structure, and the platform body has four sides,
four corners of the platform body are set as the first compartments, and correspondingly, middle portions of the four sides of the platform body are set as the second compartments.

5. The floating platform with multi-frequency adaptive vibration damping according to claim 2, wherein the first compartment and the second compartment are set as rectangular regions, a water depth ratio of water in the first compartment is 0.15 to 0.2, a ratio of a total mass of water in the first compartment to a mass of the platform body is 1% to 4%, a water depth ratio of water in the second compartment is 0.2 to 0.3, and a ratio of a total mass of water in the second compartment to the mass of the platform body is 1% to 4%, wherein the water depth ratio is a ratio of a depth of water to a corresponding length of the compartment in a vibration direction.

6. The floating platform with multi-frequency adaptive vibration damping according to claim 2, wherein the first compartment and the second compartment are set as rectangular regions, a depth of water in the first compartment and the second compartment is calculated and obtained through the following:
$${ω}_{n} = \sqrt{\frac{n π g}{L} tanh ( \frac{n π h}{L} )} ,$$
wherein ωₙ is a n^{th}-order vibration frequency of the platform body, g is a gravitational acceleration, which is 9.8 m/s², h is the depth of water in the compartment, and L is a length of the compartment in a vibration direction.

7. The floating platform with multi-frequency adaptive vibration damping according to claim 2, wherein a damping structure is further provided inside each of the first compartment and the second compartment, and the damping structure comprises at least one of a grid, a baffle, and a column.

8. The floating platform with multi-frequency adaptive vibration damping according to claim 7, wherein the first compartment and the second compartment are set as rectangular regions, an equivalent damping coefficient of the damping structure in each of the first compartment and the second compartment is calculated and obtained through the following:
$${m}_{e q} {\ddot{x}}_{r} ( t ) + {c}_{e q} {\dot{x}}_{r} ( t ) + {k}_{e q} {x}_{r} ( t ) = - {m}_{e q} \ddot{X} ( t ) ,$$
$${m}_{e q} = \frac{8 ρ b {L}^{2}}{{π}^{3}} tanh ( \frac{π h}{L} ) , and$$
$${k}_{e q} = \frac{8 ρ g b L}{{π}^{2}} {tanh}^{2} ( \frac{π h}{L} ) ,$$
wherein \ddot{X} represents an acceleration of external excitation at a bottom portion of the compartment, t represents time, xᵣ represents a displacement of water inside the compartment relative to the compartment, m_{eq} represents an equivalent mass of water inside the compartment; c_{eq} represents the equivalent damping coefficient of the damping structure, k_{eq} represents equivalent stiffness of the tuned liquid damper formed by the compartment; ρ is a water density, L and b respectively are a length and a width of the compartment in a vibration direction, g is a gravitational acceleration, and h is a depth of water in the compartment.

9. The floating platform with multi-frequency adaptive vibration damping according to claim 8, wherein the damping structure is a perforated baffle, and setting parameters of the perforated baffle are calculated and obtained through the following:
$${c}_{e q} = 2 {m}_{e q} {ω}_{n} {ξ}_{V e q} ,$$
$${ξ}_{V e q} = {ξ}_{0} {x}_{0} ,$$
$${ξ}_{0} = \frac{16}{3 π} {tanh}^{2} ( \frac{π h}{L} ) {C}_{D} {Δ}_{V} {Θ}_{V n} \frac{1}{{L}^{2}} ,$$
$${x}_{0} = \sqrt{\frac{{X}_{0}}{2 {ξ}_{0}}} ,$$
$${C}_{D} = {( \frac{1}{{C}_{c} ( 1 - S )} - 1 )}^{2} ,$$
$$S = \frac{{A}_{s}}{{A}_{T}} ,$$
$${C}_{c} = 0.405 {e}^{- π S} + 0 \text{.595} ,$$
$${Δ}_{V} = {\int }_{- h}^{- h + {l}_{b}} \frac{{cosh}^{3} ( \frac{π ( z + h )}{L} )}{{sinh}^{3} ( \frac{π h}{L} )} dz , and$$
$${Θ}_{V n} = {\sum }_{i = 1}^{n} \vert sin ( \frac{π {x}_{i}}{L} ) \vert {sin}^{2} ( \frac{π {x}_{i}}{L} ) ,$$
wherein ωₙ is a n^{th}-order vibration frequency of the platform body, ξ_{Veq} is a linear damping ratio of the tuned liquid damper formed by the compartment, x₀ is a relative horizontal displacement amplitude value of an equivalent linear model of the compartment, X₀ is a displacement amplitude value of the external excitation at the bottom portion of the compartment, C_{D} is a pressure loss coefficient caused by the built-in perforated baffle, Δ_{V} and Θ_{Vn} are calculation parameters in a theoretical derivation process of linear damping ratio calculation, S is a shielding ratio of the perforated baffle, C_{c} is a shrinkage coefficient, Aₛ is an area of a solid portion of the perforated baffle that is immersed in water, A_{T} is a total area of the perforated baffle immersed in water, l_{b} is a height of the perforated baffle, z is a height direction, and xᵢ is a distance between an i^{th} perforated baffle and a side wall of the compartment.

10. An offshore wind power system, comprising the floating platform with multi-frequency adaptive vibration damping according to claim 1 and a wind turbine fixed to the floating platform.

11. The floating platform with multi-frequency adaptive vibration damping according to claim 3, wherein the platform body has a centrally symmetrical annular hollow structure, and the platform body has four sides,
four corners of the platform body are set as the second compartments, and correspondingly, middle portions of the four sides of the platform body are set as the first compartments.

12. The floating platform with multi-frequency adaptive vibration damping according to claim 3, wherein the platform body has a centrally symmetrical annular hollow structure, and the platform body has four sides,
three compartments are arranged on each side of the platform body, among the three compartments on each side of the platform body, the compartments located on both sides are set as the first compartments, and correspondingly, the compartment in a middle among the three compartments on each side of the platform body is set as the second compartment.

13. The floating platform with multi-frequency adaptive vibration damping according to claim 3, wherein the platform body has a centrally symmetrical annular hollow structure, and the platform body has four sides,
three compartments are arranged on each side of the platform body, among the three compartments on each side of the platform body, the compartments located on both sides are set as the second compartments, and correspondingly, the compartment in a middle among the three compartments on each side of the platform body is set as the first compartment.
